(19) United States
(12) Patent Application Publication
(10) Pub. No.: US 2010/0262852 A1
(43) Pub. Date: Oct. 14, 2010

(54) AUTOMATIC SUSPENDING APPARATUS FOR COMPUTER

(75) Inventor: SHENG-CHIEH HSU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/499,098

(22) Filed: Jul. 8, 2009

(30) Foreign Application Priority Data
Apr. 14, 2009 (CN) 200910301550.6

(51) Int. Cl. G06F 1/32; H04N 5/225

(52) U.S. Cl. 713/323; 348/207.99; 703/13

(57) ABSTRACT

An automatic suspending apparatus is electrically connected to a computer, to allow the computer to enter into a sleep state. The suspending apparatus includes an image identifying module and a control module. The image identifying module includes an image capturing device to get image information in front of the computer, and an image identifying unit to determine whether body information of a user of the computer exists in the image information. The control module includes a timing module to record time and output an enable signal, and a signal simulation module to output a sleep signal to the computer for controlling the computer to enter into the sleep state.

### BACKGROUND

1. Technical Field

The present disclosure relates to suspending apparatuses, and particularly, to an automatic suspending apparatus for a computer.

2. Description of Related Art

Cost-effective computer systems using suspending circuits to save electrical energy are developed to replace ordinary computer systems. However, the computer systems using suspending circuits need to switch operation manually, the users usually forget to do it, resulting in wasting the electrical energy.

### BRIEF DESCRIPTION OF THE DRAWINGS

FIG. 1 is a block diagram of an embodiment of an automatic suspending apparatus for a computer, the apparatus including a timing module and a signal simulation module.

FIG. 2 is a block diagram of an embodiment of the timing module of FIG. 1.

FIG. 3 is a block diagram of an embodiment of the signal simulation module of FIG. 1.

### DETAILED DESCRIPTION

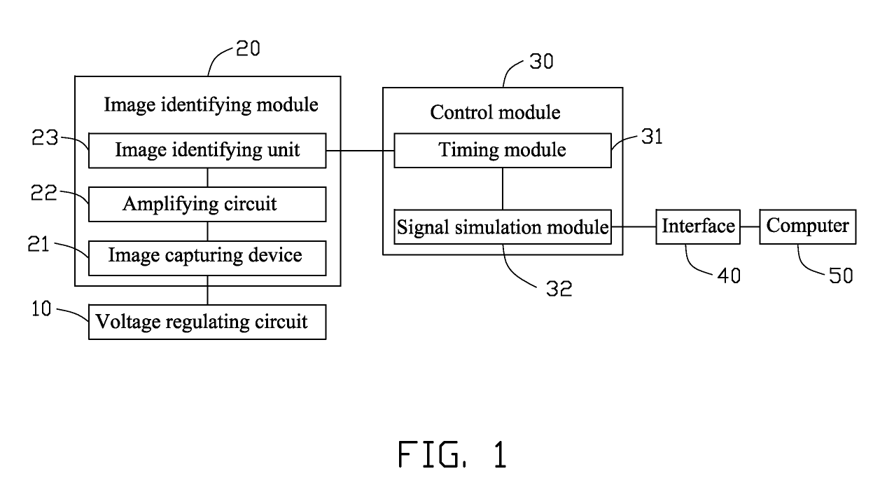

Referring to FIG. 1, an exemplary embodiment of an automatic suspending apparatus for a computer 50 includes a voltage regulating circuit 10, an image identifying module 20, a control module 30, and an interface 40 for connecting to the computer 50.

The voltage regulating circuit 10 is to be connected to an external power source to provide voltages to the image identifying module 20. The voltage regulating circuit 10 can be a known circuit, such as a voltage regulating chip 7805 or 7905. In other embodiments, the voltage regulating circuit 10 can be connected to a power supply of the computer 50 to provide voltages to the image identifying module 20.

The image identifying module 20 includes an image capturing device 21, an amplifying circuit 22, and an image identifying unit 23. The control module 30 includes a timing module 31 and a signal simulation module 32. The voltage regulating circuit 10, the image capturing device 21, the amplifying circuit 22, the image identifying unit 23, the timing module 31, the signal simulation module 32, and the interface 40 are connected in sequence. In one embodiment, the image capturing device 21 may be a camera. The amplifying circuit 22 can be a known circuit, such as, an amplifier. The interface 40 can be a universal serial bus (USB) interface.

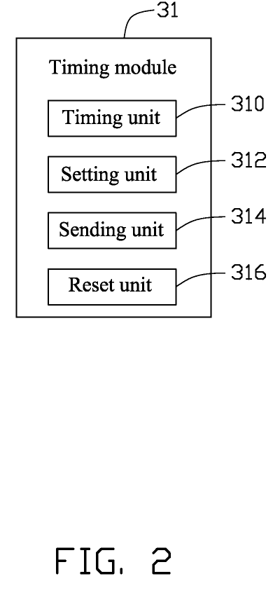

Referring to FIG. 2, the timing module 31 includes a timing unit 310, a setting unit 312, a sending unit 314, and a reset unit 316. The timing unit 310 is to record time. The setting unit 312 is to set a preset time. The sending unit 314 is to output an enable signal when the time of the timing unit 310 reaches the preset time, such as three minutes. The reset unit 316 is to clear the timing unit 310.

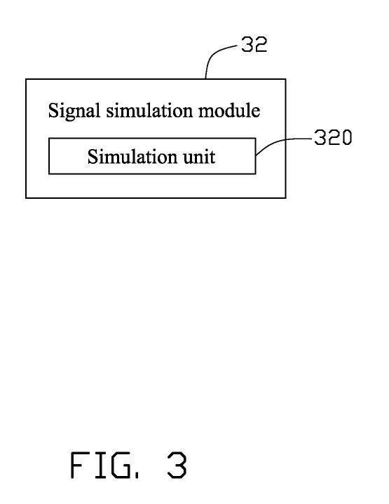

Referring to FIG. 3, the signal simulation module 32 includes a simulation unit 320. The simulation unit 320 is to simulate a sleep key of a keyboard of the computer 50. When the sleep key is pressed, the keyboard outputs a first signal to the basic input/output system (BIOS) of the motherboard of the computer 50. The BIOS controls the advanced power manager (APM) to output a control signal for controlling the computer 50 to enter into a sleep state.

The interface 40 of the automatic suspending apparatus is to be connected to a USB interface of the computer 50. The computer 50 provides voltages to the signal simulation module 32 and the timing module 31 via the USB interface of the computer 50 and the interface 40.

In use, the image capturing device 21 gets image information of a user in front of the computer 50 and sends the image information of the user to the amplifying circuit 22. The image information of the user is amplified via the amplifying circuit 22 and sent to the image identifying unit 23. The image identifying unit 23 receives the amplified image information and determines whether body information of the user of the computer 50 exists in the amplified image information according to body character data stored in the image identifying unit 23. When the body information does not exist in the image information, the image identifying unit 23 outputs a working signal to the timing module 31, to control the timing unit 310 to record time. When the recorded time reaches the preset time of the setting unit 312, the sending unit 314 sends an enable signal to the signal simulation module 32. The signal simulation module 32 outputs a sleep signal to the computer 50 via the interface 40 according to the enable signal, to control the computer 50 to enter into the sleep state. In one embodiment, the image identifying unit 23 may use existing face detecting technology to determine whether body information exists in the image information.

When the body information exists in the image information, the image identifying unit 23 outputs an interrupt signal to the timing module 31. The reset unit 316 of the timing module 31 receives the interrupt signal from the image identifying unit 23, and clears the timing unit 310 according to the interrupt signal.

The automatic suspending apparatus determines whether body information of the user of the computer 50 exists, via the image identifying module 20. Once the body information of the user does not exist in the image information, the control module 30 will control the computer 50 to enter into the sleep state. Therefore, the automatic suspending apparatus is power-saving.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching. The embodiments were chosen and described in order to explain the principles of the disclosure and their practical application so as to enable others skilled in the art to utilize the disclosure and various embodiments and with various modifications as are suited to the particular use contemplated. Alternately embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. An automatic suspending apparatus for connecting to a computer to allow the computer to enter into a sleep state, the suspending apparatus comprising:
an image identifying module comprising:
an image capturing device to capture image information in front of the computer; and
an image identifying unit to receive the image information from the image capturing device and determine whether body information of a user exists in the image information; and
a control module comprising:
a timing module to receive a working signal from the image identifying unit in response to the body information not existing in the image information, record time according to the working signal, and output an enable signal in response to the recorded time reaching a preset time; and
a signal simulation module to receive the enable signal and output a sleep signal according to the enable signal to the computer, for controlling the computer to enter into the sleep state.

2. The suspending apparatus of claim 1, wherein the timing module is also operable to receive an interrupt signal from the image identifying unit and clear the timing module, in response to the body information existing in the image information.

3. The suspending apparatus of claim 1, further comprising a voltage regulating circuit, wherein the voltage regulating circuit is to be connected to a power source to provide voltages to the image identifying module.

4. The suspending apparatus of claim 1, wherein the image identifying module further comprises an amplifying circuit connected between the image capturing device and the image identifying unit, to amplify the image information gotten by the image capturing device.

5. The suspending apparatus of claim 1, wherein the image capturing device is a camera.

6. The suspending apparatus of claim 1, wherein the timing module comprises:
a timing unit to record time when the timing module receives the working signal from the image identifying unit;
a setting unit to set the preset time;
a sending unit to output the enable signal to the signal simulation module in response to the record time of the timing unit reaching the preset time; and
a reset unit to clear the time unit according to the interrupt signal.

7. The suspending apparatus of claim 1, wherein the signal simulation module comprises a simulation unit to receive the enable signal from the sending unit, and output the sleep signal to the computer according to the enable signal.

8. The suspending apparatus of claim 1, wherein the signal simulation module is connected to the computer via an interface.

9. The suspending apparatus of claim 8, wherein the interface is a universal serial bus interface.
